(19) United States
(12) Patent Application Publication
(10) Pub. No.: US 2011/0099065 A1
(43) Pub. Date: Apr. 28, 2011

(54) System and method for broadcasting advertisements to client devices in an electronic network

(75) Inventors: Nikolaos Georgis, San Diego, CA (US); Fredrik Carpio, San Diego, CA (US); Milton Frazier, San Marcos, CA (US)

(73) Assignees: Sony Corporation; Sony Electronics Inc.

(21) Appl. No.: 12/589,582

(22) Filed: Oct. 26, 2009

(51) Int. Cl. G06Q 30/00

(52) U.S. Cl. 705/14.52; 705/14.64

(57) ABSTRACT

A system and method for supporting advertisement distribution in an electronic network includes an ad server that collects statistics for specifically targeting advertisements to device users in the electronic network. A recommendation engine then analyzes the collected statistics to create recommendation lists of ranked advertisement candidates for transmitting to client devices of the device users. A high-power wireless transmitter broadcasts the targeted advertisements to the client devices in a multicast procedure.

### BACKGROUND SECTION

1. Field of the Invention

This invention relates generally to techniques for managing electronic information, and relates more particularly to a system and method for broadcasting advertisements to client devices in an electronic network.

2. Description of the Background Art

Implementing effective methods for managing electronic information is a significant consideration for designers and manufacturers of contemporary electronic devices. However, effectively managing information utilized by devices in an electronic network may create substantial challenges for system designers. For example, enhanced demands for increased device functionality and performance may require more system processing power and require additional software resources. An increase in processing or software requirements may also result in a corresponding detrimental economic impact due to increased production costs and operational inefficiencies.

Furthermore, enhanced device capability to perform various advanced data management operations may provide additional benefits to a system user, but may also place increased demands on the control and management of various system components. For example, an enhanced electronic network device that effectively manages electronic advertising information may benefit from an effective implementation because of the large amount and complexity of the digital data involved.

Due to growing demands on system resources and substantially increasing data magnitudes, it is apparent that developing new techniques for managing information in electronic networks is a matter of concern for related electronic technologies. Therefore, for all the foregoing reasons, developing effective techniques for managing information in electronic networks remains a significant consideration for designers, manufacturers, and users of contemporary electronic devices.

### SUMMARY

In accordance with the present invention, a system and method for supporting advertisement distribution in an electronic network are disclosed. In one embodiment, an appropriate design or control entity initially defines one or more effective targeting criteria to identify advertisements or other information for broadcasting to client devices in an electronic network. An ad server then collects and stores various relevant statistics corresponding to the predefined targeting criteria in any effective manner.

A recommendation engine of the ad server utilizes a pattern recognizer to carefully analyze and cross-correlate the collected statistics. The recommendation engine utilizes the statistics and pattern data from the pattern recognizer to create a ranked recommendation list of advertisement candidates for broadcast to the client devices in the electronic network. The ad server also specifies one or more appropriate transmission times for broadcasting at least one of the top-ranked advertisements candidates to the client devices.

The selected advertisement(s) and transmission time(s) are then provided to a transmitter for broadcast to the client devices. The transmitter may be implemented in any effective manner. For example, in certain embodiments, the transmitter wirelessly broadcasts electronic information unidirectionally to the client devices in accordance with known or enhanced standards from an Advanced Television Standards Committee (ATSC).

The transmitter performs a multicasting procedure to broadcast the selected advertisement(s) to the client devices. The client devices responsively utilize respective receivers and download managers to receive and locally store the transmitted advertisement(s) for viewing by the device users. For at least the foregoing reasons, the present invention therefore provides an improved system and method for effectively supporting an advertisement distribution procedure in an electronic network.

### BRIEF DESCRIPTION OF THE DRAWINGS

FIG. 1A is a block diagram of an electronic network, in accordance with one embodiment of the present invention;

FIG. 1B is a block diagram of the peer-to-peer network of FIG. 1A, in accordance with one embodiment of the present invention;

FIG. 1C is a block diagram of the transmitter of FIG. 1A, in accordance with one embodiment of the present invention;

FIG. 1D is a block diagram of the transmitter memory of FIG. 1C, in accordance with one embodiment of the present invention;

FIG. 2 is a block diagram for one embodiment of the ad server of FIG. 1A, in accordance with the present invention;

FIG. 3 is a block diagram for one embodiment of the server memory of FIG. 2, in accordance with the present invention;

FIG. 4A is a block diagram of the recommendation engine from FIG. 3, in accordance with one embodiment of the present invention;

FIG. 4B is a block diagram of a recommendation list from FIG. 4A, in accordance with one embodiment of the present invention;

FIG. 5 is a block diagram for one embodiment of a client device from FIG. 1A, in accordance with the present invention;

FIG. 6 is a block diagram for one embodiment of the device memory of FIG. 5, in accordance with the present invention; and

FIGS. 7A and 7B are a flowchart of method steps for supporting an advertisement distribution procedure, in accordance with one embodiment of the present invention.

### DETAILED DESCRIPTION

The present invention relates to an improvement in electronic information management techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Therefore, the present invention is not intended to be limited to the embodiments shown, but is to be accorded the widest scope consistent with the principles and features described herein.

The present invention comprises a system and method for supporting advertisement distribution in an electronic network, and includes an ad server that collects statistics for specifically targeting advertisements to device users in the electronic network. A recommendation engine then analyzes the collected statistics to create recommendation lists of ranked advertisement candidates for transmitting to client devices of the device users. A high-power wireless transmitter broadcasts the targeted advertisements to the client devices in a multicast procedure.

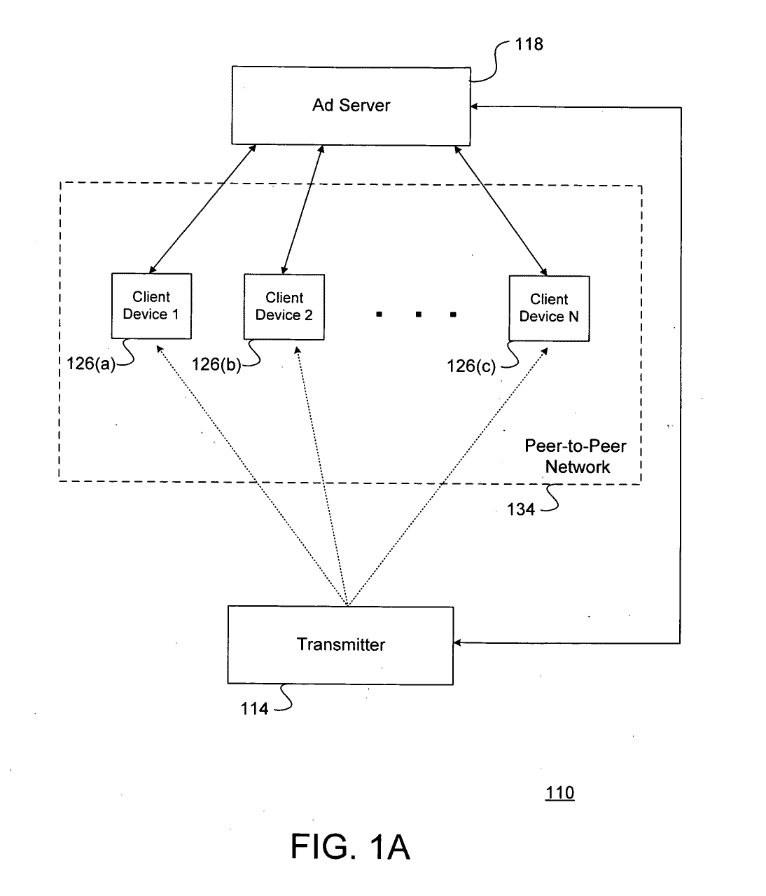

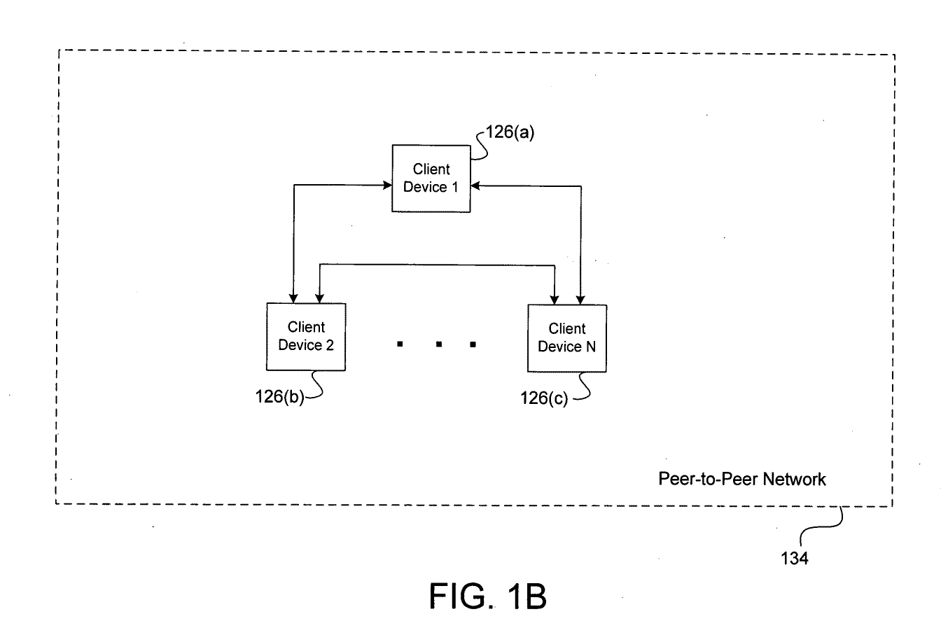

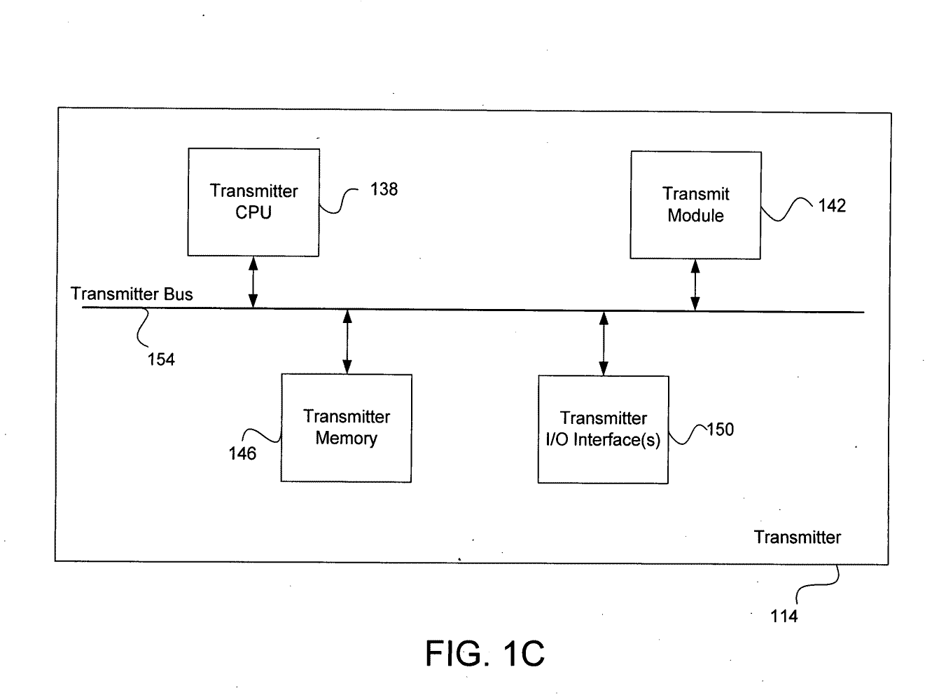

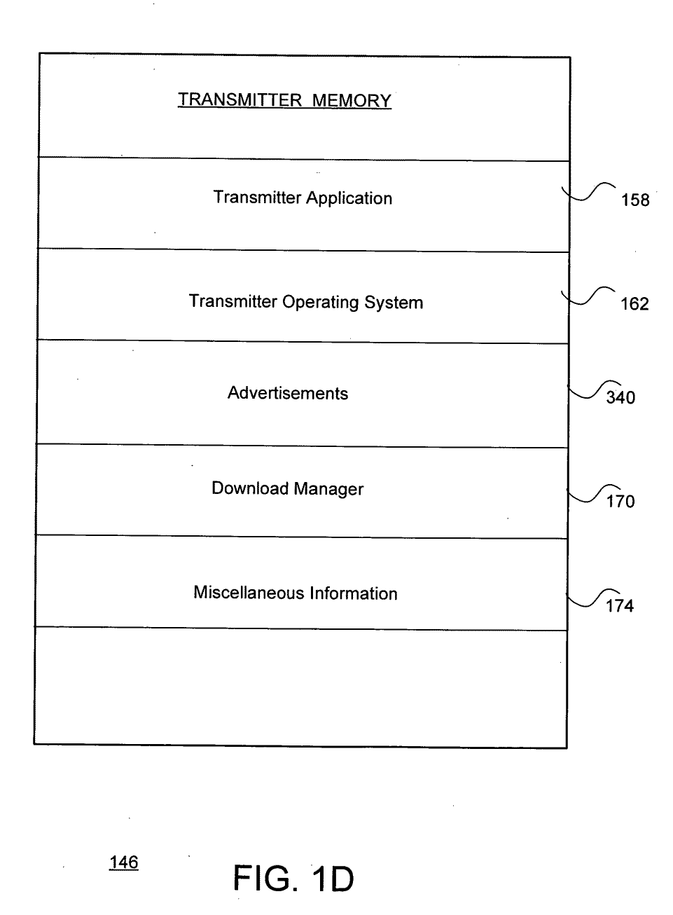

Referring now to FIG. 1A, a block diagram of an electronic network 110 is shown, in accordance with one embodiment of the present invention. In the FIG. 1A embodiment, electronic network 110 may include, but is not limited to, a transmitter 114, an ad server 118, and a plurality of client devices 126. In alternate embodiments, electronic network 110 may be implemented by utilizing components and configurations in addition to, or instead of, certain of those components and configurations discussed in conjunction with the FIG. 1A embodiment.

In accordance with one embodiment of the present invention, any desired number of client devices 126 may optionally be configured in a peer-to-peer network 134 that is further discussed below in conjunction with FIG. 1B. In certain alternate embodiments, some or all of the client devices 126 may not be included within peer-to-peer network 134. In the FIG. 1A embodiment, client devices 126 may include an electronic device 1 (126(a)) through an electronic device N 126(c). In the FIG. 1A embodiment, each of the client devices 126 may bi-directionally communicate directly with other ones of the client devices 126 by utilizing any appropriate peer-to-peer communication techniques or other effective communication methods.

In accordance with the present invention, transmitter 114 may received one or more advertisements from any appropriate advertisement source. For example, transmitter 114 may receive advertisements from ad server 118 or another appropriate entity. The advertisements may include any desired types of electronic information. For example, advertisements may include, but are not limited to, video data, audio data, digital photographs, still image data, graphics, web pages, text data, and various types of software programs, etc.

In the FIG. 1A embodiment, transmitter 114 may then perform a multicast procedure to simultaneously broadcast a unidirectional data stream that includes one or more appropriate advertisements to a plurality of the client devices 126. In the FIG. 1A embodiment, transmitter 114 may be implemented as a high-power wireless radio-frequency transmitter device that has a transmission range of approximately fifty miles or more, depending upon the selected operating frequency and operating power.

In the FIG. 1A embodiment, ad server 118 continually performs a statistics-gathering procedure to obtain and store specific statistics for accurately targeting advertisements to the various device users of the respective client devices 126. In the FIG. 1A embodiment, client devices 126 may communicate with ad server 118 via a back channel or other appropriate means to provide the statistics. The back channel may include any effective communication path between the client devices 126 and ad server 118. In certain embodiments, the back channel may include, but is not limited to, Internet connections between respective client devices 126 and ad server 118. In certain embodiments, after receiving a given advertisement, the client devices 126 may provide feedback information via the back channel to ad server 118.

The present invention provides an intelligent way of predicting customer demand by carefully collecting statistics from different geographical markets and pushing appropriate advertising material to target markets. Traditionally, advertising has been a one-way operation occurring globally. However, the existence of the back channel in the FIG. 1A broadcast environment may be utilized to provide additional statistical information for enhancing advertising accuracy and effectiveness.

By carefully cross-correlating the logged statistical data, the present invention may predict events or trends that are likely to happen to certain geographical locations. An immediate action would to be to push appropriate targeted advertising material, like video/audio clips, images, audio recordings, songs, or other multimedia material to mobile handsets or other appropriate devices using transmitter 114. The proposed technique dynamically adapts based on current market characteristics and feedback information. Global optimization models may be utilized to ensure maximization of revenue. A powerful pattern recognizer may be employed to perform advanced statistical analysis on the collected statistics. The present invention may thus be utilized by advertising companies to push advertising material to client devices 126 in an intelligent and efficient way. Additional details regarding these advertisement distribution procedures are further discussed below in conjunction with FIGS. 1B-7B.

Referring now to FIG. 1B, a block diagram of the FIG. 1A peer-to-peer network 134 is shown, in accordance with one embodiment of the present invention. The FIG. 1B embodiment includes a client device 1 (126(a)), a client device 2 (126(b)), through a client device N (126(a)). In alternate embodiments, peer-to-peer network 134 may be implemented by utilizing components and configurations in addition to, or instead of, certain of those components and configurations discussed in conjunction with the FIG. 1B embodiment. Furthermore, peer-to-peer network 134 may be implemented to include any desired number of client devices 126.

In the FIG. 1B embodiment, each of the client devices 126 may bi-directionally communicate directly with any other of the client devices 126 by utilizing any desired peer-to-peer communication techniques or other effective communication methods. For example, client device 1 (126(a)) may bi-directionally communicate directly with either client device 2 (126(b)) or client device N (126(c)). Similarly, client device 2 (126(b) may bi-directionally communicate directly with client device N (126(c)). Furthermore, in the FIG. 1B embodiment, any of the client devices 126 in peer-to-peer network 134 may perform a peer-to-peer advertisement transfer procedure to transfer advertisements to any of the other client devices 126 in peer-to-peer network 134. Additional details regarding the utilization of the FIG. 1B peer-to-peer network 134 are further discussed below in conjunction with FIGS. 1C-7B.

Referring now to FIG. 1C, a block diagram for one embodiment of the FIG. 1A transmitter 114 is shown, in accordance with the present invention. In the FIG. 1C embodiment, transmitter 114 includes, but is not limited to, a transmitter central-processing unit (transmitter CPU) 138, a transmit module 142, a transmitter memory 146, and one or more transmitter input/output interface(s) (transmitter I/O interface(s)) 150. The foregoing components of transmitter 114 may be coupled to, and communicate through, a transmitter bus 154. In alternate embodiments, transmitter 114 may alternately be implemented using components and configurations in addition to, or instead of, certain of those components and configurations discussed in conjunction with the FIG. 1C embodiment.

In the FIG. 1C embodiment, transmitter CPU 138 may be implemented to include any appropriate and compatible microprocessor device that preferably executes software instructions to thereby control and manage the operation of transmitter 114. The FIG. 1C transmitter 114 may utilize transmit module 142 to send electronic information to one or more electronic devices 126 (FIG. 1A) by utilizing any effective type of wireless or wired communication techniques. For example, in certain embodiments, transmitter 114 may include a commercial television broadcast transmitter. Furthermore, in certain embodiments, transmitter 114 may be implemented to broadcast electronic information according to known or enhanced standards from the Advanced Television Standards Committee (ATSC).

In the FIG. 1C embodiment, transmitter memory 146 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of transmitter memory 146 are further discussed below in conjunction with FIG. 1D.

In the FIG. 1C embodiment, transmitter I/O interface(s) 150 may include one or more input and/or output interfaces to receive and/or transmit any required types of information by transmitter 114. Transmitter I/O interface(s) 150 may include one or more means for allowing a transmitter user to communicate with transmitter 114. In the FIG. 1C embodiment, transmit module 142 may include any appropriate technologies to support broadcasts from transmitter 114 to client devices 126 (FIG. 1A). For example, in certain embodiments, transmit module 142 may include a high-voltage transmission power supply, radio-frequency transmitter hardware components, and a broadcasting antennae array that is mounted on an elevated broadcasting tower to support long-range wireless multicasts to client devices 126. The implementation and utilization of transmitter 114 is further discussed below in conjunction with FIGS. 1D-7B.

Referring now to FIG. 1D, a block diagram for one embodiment of the FIG. 1C transmitter memory 146 is shown, in accordance with the present invention. In the FIG. 1D embodiment, transmitter memory 146 may include, but is not limited to, a transmitter application 158, a transmitter operating system 162, one or more advertisements 340, a download manager 170, and miscellaneous information 174. In alternate embodiments, transmitter memory 146 may include various other components and functionalities in addition to, or instead of, certain those components and functionalities discussed in conjunction with the FIG. 1D embodiment.

In the FIG. 1D embodiment, transmitter application 158 may include program instructions that are preferably executed by transmitter CPU 138 (FIG. 1C) to perform various functions and operations for transmitter 114. The particular nature and functionality of transmitter application 158 typically varies depending upon factors such as the specific type and particular functionality of the corresponding transmitter 114. Transmitter operating system 162 may perform various low-level functions for transmitter 114.

In the FIG. 1D embodiment, advertisements 340 may include any appropriate type of advertisements or other information received by transmitter application 158 from ad server 118 (FIG. 1A) or other appropriate entity. For example, in certain embodiments, advertisements 340 may include, but are not limited to, any types of video data, audio data, digital photographs, still image data, graphics, web pages, text data, and various types of software programs, etc.

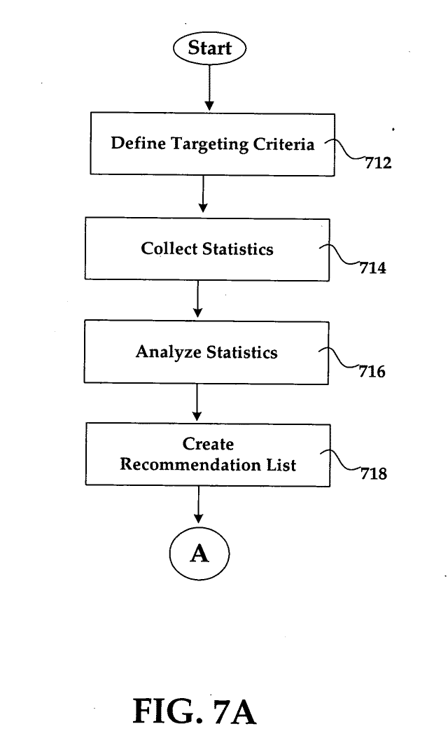

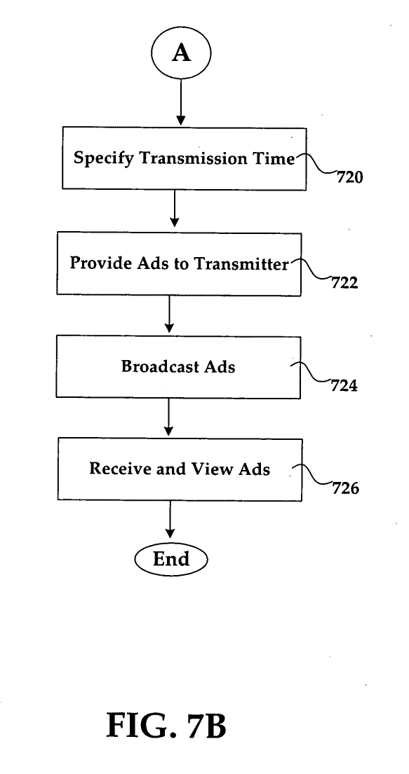

In the FIG. 1D embodiment, download manager 170 may be utilized to coordinate transmission procedures to concurrently transmit television programming as well as advertisement distribution, in accordance with the present invention. In the FIG. 1D embodiment, miscellaneous information 174 may include any appropriate additional information or data that is required by transmitter 114. Additional details regarding the operation of download manager 170 are further discussed below in conjunction with FIG. 7.

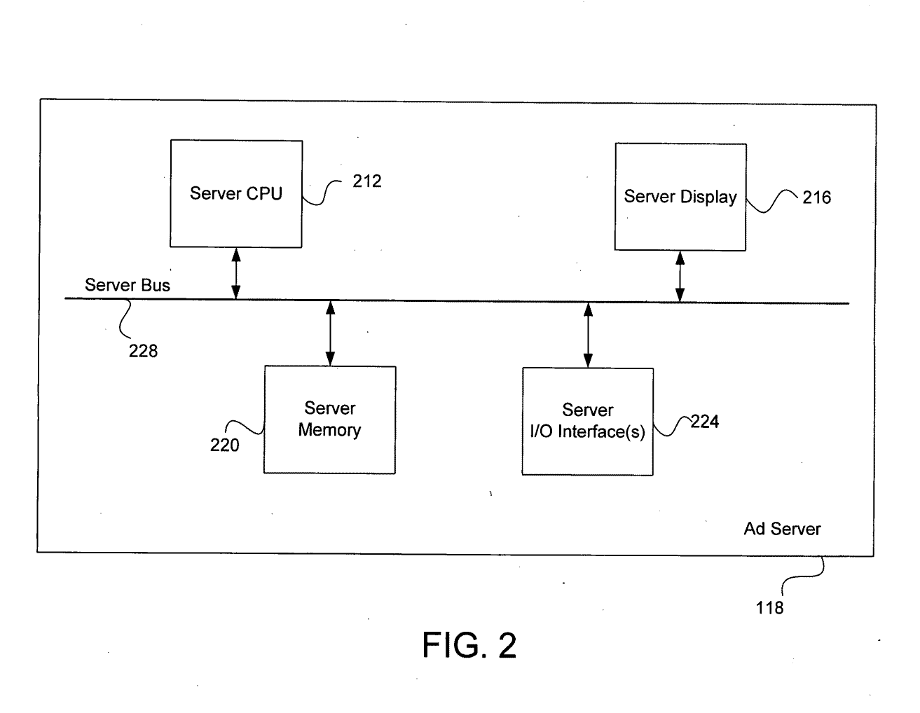

Referring now to FIG. 2, a block diagram for one embodiment of the FIG. 1A ad server 118 is shown, in accordance with the present invention. In the FIG. 2 embodiment, ad server 118 includes, but is not limited to, a server central processing unit (server CPU) 212, a server display 216, a server memory 220, and one or more server input/output interface(s) (server I/O interface(s)) 224. The foregoing components of ad server 118 may be coupled to, and communicate through, a server bus 228. In alternate embodiments, ad server 118 may alternately be implemented using components and configurations in addition to, or instead of, certain of those components and configurations discussed in conjunction with the FIG. 2 embodiment.

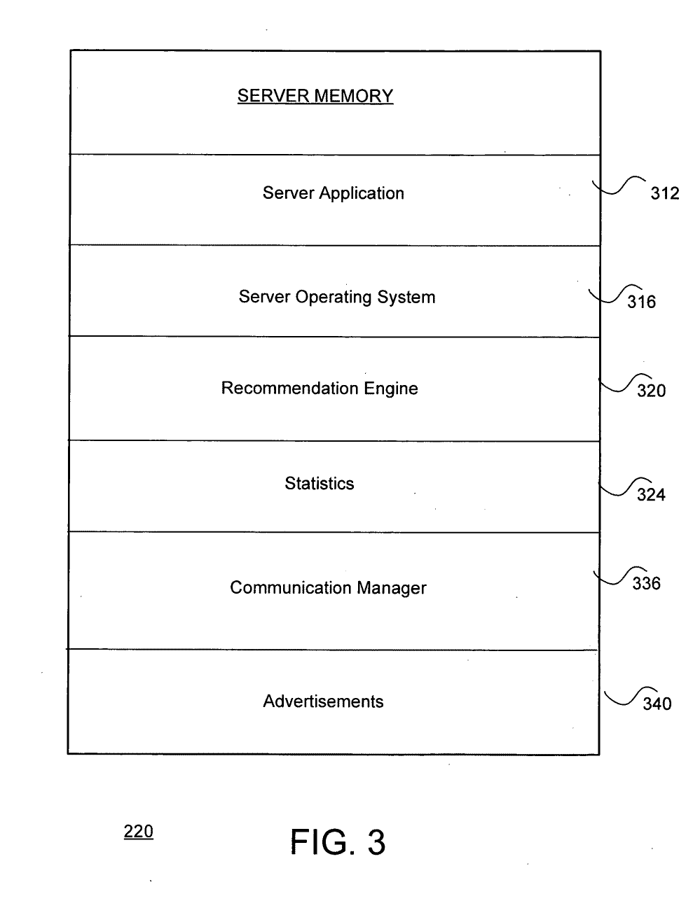

In the FIG. 2 embodiment, server CPU 212 may be implemented to include any appropriate and compatible microprocessor device that preferably executes software instructions to thereby control and manage the operation of ad server 118. The FIG. 2 server display 216 may include any effective type of display technology including a cathode-ray-tube monitor or a liquid-crystal display device with an appropriate screen for displaying various information to a server user. In the FIG. 2 embodiment, server memory 220 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of server memory 220 are further discussed below in conjunction with FIG. 3.

In the FIG. 2 embodiment, server I/O interface(s) 224 may include one or more input and/or output interfaces to receive and/or transmit any required types of information by ad server 118. Server I/O interface(s) 224 may include one or more means for allowing a server user to communicate with ad server 118. The utilization of ad server 118 is further discussed below in conjunction with FIGS. 3-4 and 7.

Referring now to FIG. 3, a block diagram for one embodiment of the FIG. 2 server memory 220 is shown, in accordance with the present invention. In the FIG. 3 embodiment, server memory 220 may include, but is not limited to, a server application 312, a server operating system 316, a recommendation engine 320, statistics 324, a communication manager 336, and advertisements 340. In alternate embodiments, server memory 220 may include various other components and functionalities in addition to, or instead of, certain those components and functionalities discussed in conjunction with the FIG. 3 embodiment.

In the FIG. 3 embodiment, server application 312 may include program instructions that are preferably executed by server CPU 212 (FIG. 2) to perform various functions and operations for ad server 118. The particular nature and functionality of server application 312 typically varies depending upon factors such as the specific type and particular functionality of the corresponding ad server 118. Server operating system 316 may perform various low-level functions for ad server 118.

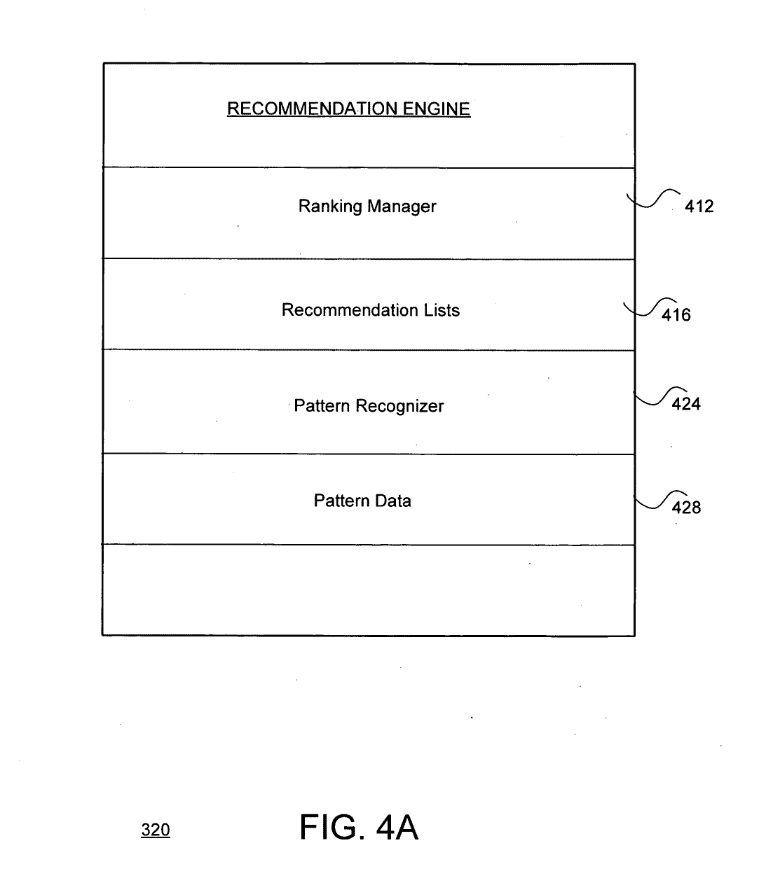

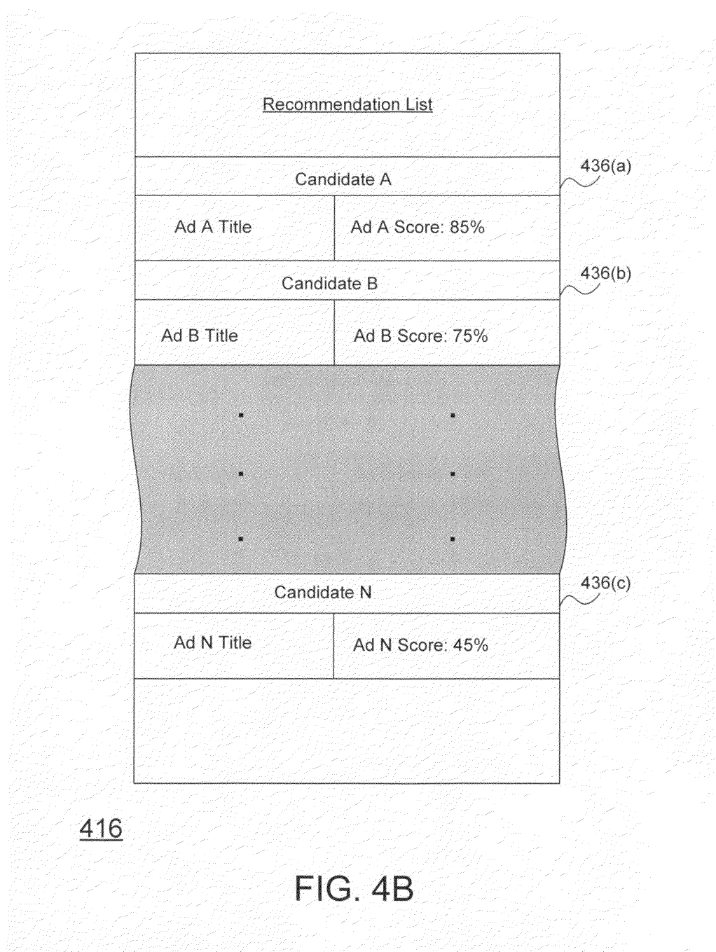

In the FIG. 3 embodiment, recommendation engine 320 may include any effective means for selecting one or more recommended candidates from advertisements 340 or other information for transmitting to client devices 126 via transmitter 114 (FIG. 1A). Additional details regarding recommendation engine 320 are further discussed below in conjunction with FIGS. 4A-4B. In the FIG. 3 embodiment, statistics 324 may include any types of information that recommendation engine 320 may then analyze to identify the recommended candidates from advertisements 340.

For example, statistics 324 may include, but are not limited to, reported observations of contemporaneous occurrences, specific events from the recent or more distant past, information regarding one or more specific geographical locations, weather conditions, notifications of future scheduled events, device user profile information, user device or network configurations, demographic data, Internet browsing patterns, information related to one or more commercial products, advertisement formats, and advertiser information for one or more advertisers.

In accordance with the present invention, statistics 324 may be collected in any effective manner. For example, device users may provide appropriate statistics 324 in response to one or more statistics questionnaires. Furthermore, client devices 126 may automatically or manually provide statistics 324 to ad server 118. In addition, ad server 118 may periodically poll client devices 126 or other appropriate entities to obtain statistics 324.

In the FIG. 3 embodiment, communication manager 336 may perform appropriate communication functions with client devices 126 and transmitter 114 to transfer any appropriate type of information. In the FIG. 3 embodiment, advertisements 340 may include supported message, content, and other appropriate information for providing to transmitter 114 for broadcast to client devices 126. Additional details regarding the operation and implementation of ad server 118 are further discussed below in conjunction with FIGS. 4 and 7.

Referring now to FIG. 4A, a diagram for one embodiment of the FIG. 3 recommendation engine 320 is shown, in accordance with the present invention. In the FIG. 4 embodiment, recommendation engine 320 may include, but is not limited to, a ranking manager 412, recommendation lists 416, a pattern recognizer 424, and pattern data 428. In alternate embodiments, recommendation engine 320 may include other elements and configurations in addition to, or instead of, certain of those elements and configurations discussed in conjunction with the FIG. 4A embodiment.

In the FIG. 4A embodiment, recommendation engine 320 may utilize a ranking manager 412 for analyzing various relevant types of statistics 324 (FIG. 3) or pattern data 428 to thereby generate corresponding one of the recommendation lists 416. One embodiment for implementing a recommendation list 416 is further discussed below in conjunction with FIG. 4B. In the FIG. 4A embodiment, recommendation engine 320 may utilize pattern recognizer 424 to analyze and cross-correlate various predefined statistics 324 (FIG. 3) to develop corresponding pattern data 428. For example, in certain embodiments, pattern recognizer 424 may tabulate the number of observations of each predefined category or instance of the respective statistics 324. The functionality and utilization of recommendation engine 320 are further discussed below in conjunction with FIGS. 4B and 7.

Referring now to FIG. 4B, a diagram for one embodiment of a FIG. 4 recommendation list 416 is shown, in accordance with the present invention. In the FIG. 4B embodiment, recommendation list 416 includes, but is not limited to, a ranked series of candidates 436 that each represent a different advertisement or other appropriate item from ad server 118 (see FIG. 1A). In alternate embodiments, recommendation list 416 may include other components and information in addition to, or instead of, certain of those components and information discussed in conjunction with the FIG. 4B embodiment.

In the FIG. 4B embodiment, recommendation list 416 includes a candidate A 436(a) through a candidate N 436(c) that each has a corresponding ad title and ad ranking score. For example, the FIG. 4B candidate A 436(a) includes an ad A title and an ad A score of 85%. In the FIG. 4B embodiment, candidate A 436(a) is therefore the optimal candidate based upon the highest ad ranking score. In alternate embodiments, particular advertisements may be identified by any other appropriate ad designation. For example, advertisements may be identified by an ad identification number. In addition, in certain embodiments, ranking indicators for the download candidates 436 may be implemented in any other effective manner. For example, a numerical merit indicator other than a percentage may alternately be utilized.

In the FIG. 4B embodiment, a ranking manager 412 of recommendation engine 320 (FIG. 4A) calculates the ad ranking scores to generate the ranked recommendation list 416 by analyzing any appropriate types of information. For example, ranking manager 412 may generate recommendation list 416 for a given broadcast by analyzing pre-determined ranking criteria that may include information from statistics 324 (FIG. 3) and pattern data 424 (FIG. 4A).

Furthermore, ranking manager 412 may analyze the predetermined ranking criteria/factors by utilizing any effective techniques and procedures. For example, in certain embodiments, ranking manager 412 may perform a weighted averaging of observances of the different ranking factors from the ranking criteria to determine a cost function that represents the likelihood of a device user selecting and paying for the advertised item. Each of the various ranking factors may be associated with a different weighting value that represents the approximate significance of the corresponding ranking factor. The generation and utilization of recommendation lists 416 are further discussed below in conjunction with FIGS. 7A-B.

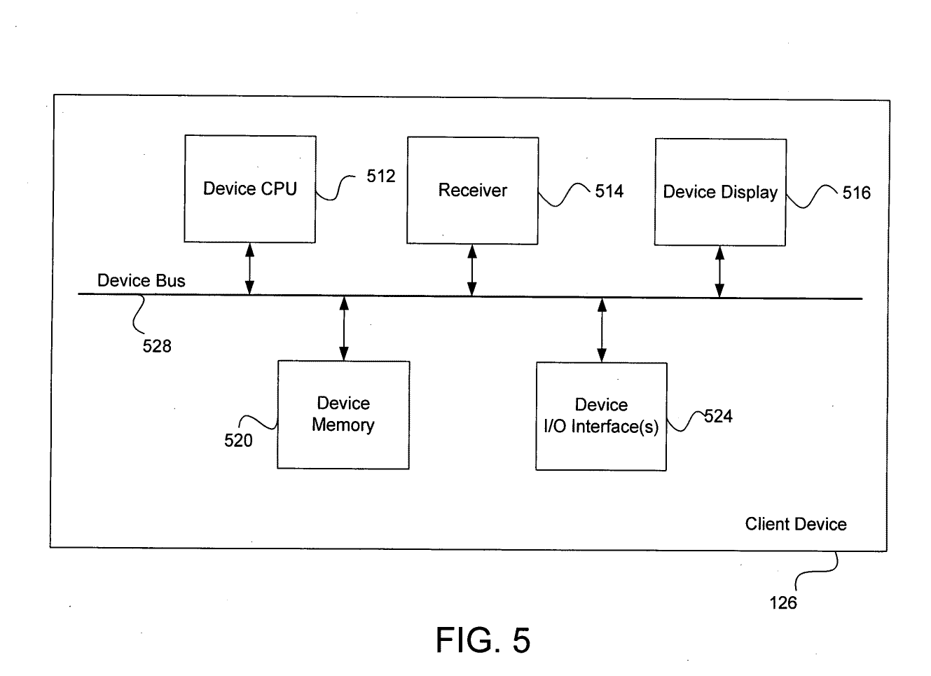

Referring now to FIG. 5, a block diagram for one embodiment of a FIG. 1A client device 126 is shown, in accordance with the present invention. In the FIG. 5 embodiment, client device 126 may include, but is not limited to, a device central processing unit (device CPU) 512, a receiver 514, a device display 516, a device memory 520, and one or more device input/output interface(s) (device I/O interface(s)) 524. The foregoing components of client device 126 may be coupled to, and communicate through, a device bus 528.

In alternate embodiments, client device 126 may readily be implemented using various components and configurations in addition to, or instead of, certain of those components and configurations discussed in conjunction with the FIG. 5 embodiment. Furthermore, in the FIG. 5 embodiment, client device 126 may be implemented as any type of appropriate electronic device. For example, in certain embodiments, client device 126 may be implemented as any type of stationary or portable electronic device, such as a personal computer, a television, a consumer-electronics device, a cellular telephone, a settop box, an audio-visual entertainment device, or a personal digital assistant (PDA).

In the FIG. 5 embodiment, device CPU 512 may be implemented to include any appropriate and compatible microprocessor device that preferably executes software instructions to thereby control and manage the operation of client devices 126. In the FIG. 5 embodiment, receiver 514 may include any effective means of receiving broadcasts or transmissions from an external entity. For example, receiver 514 may be configured to wirelessly receive transmissions from transmitter 114, as discussed above in conjunction with FIG. 1A.

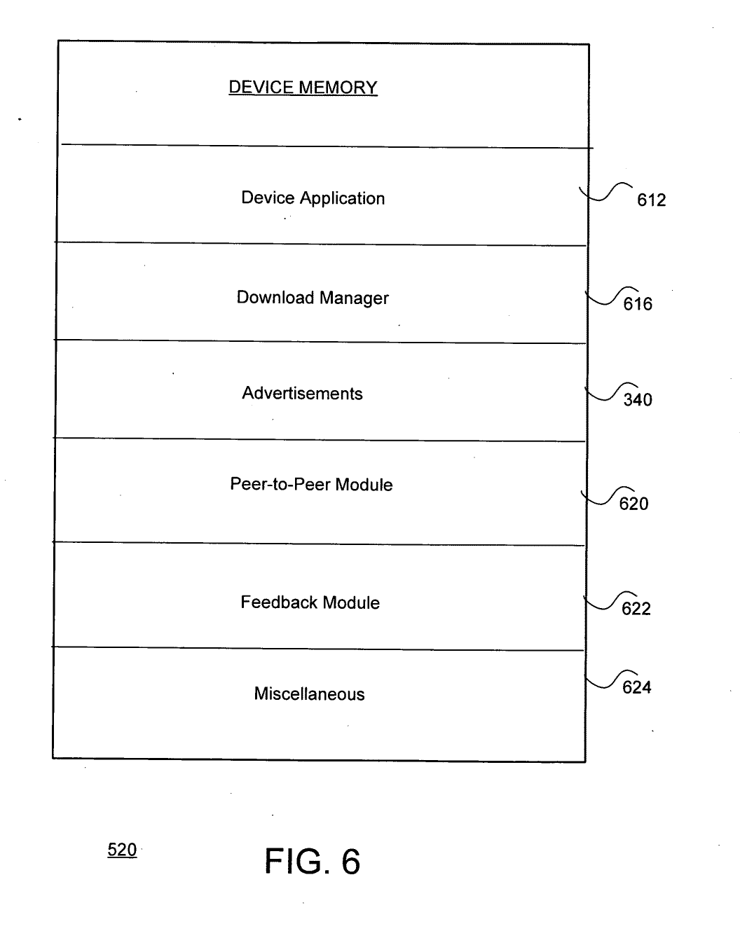

The FIG. 5 device display 516 may include any effective type of display technology including a cathode-ray-tube monitor or a liquid-crystal display device with an appropriate screen for displaying various information to a device user. In the FIG. 5 embodiment, device memory 520 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of device memory 520 are further discussed below in conjunction with FIG. 6.

In the FIG. 5 embodiment, device I/O interface(s) 524 may include one or more input and/or output interfaces to receive and/or transmit any required types of information by client device 126. Device I/O interface(s) 524 may include one or more means for allowing a device user to communicate with other entities in electronic network 110 (FIG. 1A). For example, the foregoing means may include a keyboard device, a wireless remote-control device, a speech-recognition module with corresponding microphone, a graphical user interface with touch-screen capability, a hand-held device controller unit, or a selection button array mounted externally on client device 126. The implementation and utilization of client device 126 are further discussed below in conjunction with FIGS. 6-7.

Referring now to FIG. 6, a block diagram for one embodiment of the FIG. 5 device memory 520 is shown, in accordance with the present invention. In the FIG. 6 embodiment, device memory 520 includes, but is not limited to, a device application 612, a download manager 616, advertisements 340, a peer-to-peer module 620, a feedback module 622, and miscellaneous items 624. In alternate embodiments, device memory 520 may include components and functionalities in addition to, or instead of, certain of those components and functionalities discussed in conjunction with the FIG. 6 embodiment.

In the FIG. 6 embodiment, device application 612 may include program instructions that are preferably executed by a device CPU 512 (FIG. 5) to perform various functions and operations for a client device 126. The particular nature and functionality of device application 612 typically varies depending upon factors such as the specific type and particular functionality of the corresponding client device 126.

In the FIG. 6 embodiment, download manager 616 may perform communication procedures for exchanging electronic information with external entities by utilizing any appropriate techniques. For example, download manager 616 may coordinate advertisement download procedures to automatically receive and locally store broadcasted advertisements 340 from transmitter 114 (FIG. 1A). In the FIG. 6 embodiment, advertisements 340 may include either information that was broadcast from transmitter 114, or information that was received from other client devices 126.

In the FIG. 6 embodiment, peer-to-peer module 620 may be utilized by a particular client device 126 to directly communicate with any other client device 126 in peer-to-peer network 134 (FIG. 1B). For example, peer-to-peer module 620 may perform an ad transfer procedure to obtain downloaded advertisements from other client devices 126 in peer-to-peer network 134. In the FIG. 6 embodiment, feedback module 622, may communicate with ad server 118 (FIG. 1A) or other appropriate entity to provide statistics 324 (FIG. 3) or feedback information one the effectiveness of advertisements 340 received by client device 126. Miscellaneous information 624 may include any additional information that for utilization by client device 126. The utilization and implementation of client device 126 is further discussed below in conjunction with FIG. 7.

Referring now to FIGS. 7A and 7B, a flowchart of method steps for supporting an advertisement distribution procedure is shown, in accordance with one embodiment of the present invention. The FIG. 7 flowchart is presented for purposes of illustration, and in alternate embodiments, the present invention may utilize steps and sequences other than those steps and sequences discussed in conjunction with the FIG. 7 embodiment.

In step 712 of FIG. 7A, an appropriate design or control entity initially defines one or more effective targeting criteria for identifying advertisements 340 for broadcasting to client devices 126 in an electronic network 110. In step 714, an ad server 118 collects and stores statistics 324 corresponding the predefined targeting criteria in any effective manner. In step 716, a recommendation engine 320 of the ad server 118 utilizes a pattern recognizer 424 to carefully analyze and cross-correlate the collected statistics 324.

In step 718, the recommendation engine 320 utilizes statistics 324 and pattern data 428 from the pattern recognizer 424 to create a ranked recommendation list 416 of advertisement candidates 436 for broadcast to the client devices 126 in the electronic network 110. The FIG. 7A process then advances to step 720 of FIG. 7B through connecting letter “A.”

In step 720, the ad server 118 specifies one or more appropriate transmission times for broadcasting at least one of the top-ranked advertisements candidates 436 to the client devices 126. In step 722, the selected advertisement(s) 340 and transmission time(s) are provided to a transmitter 114 (FIG. 1A) for transmission. The transmitter 114 may be implemented in any effective manner. For example, in certain embodiments, the transmitter 114 wirelessly broadcasts electronic information unidirectionally to client devices 126 in accordance with known or enhanced standards from an Advanced Television Standards Committee (ATSC).

In step 724, the transmitter 114 performs a multicasting procedure to broadcast the selected advertisement(s) 340 to the client devices 126. In step 726, the client devices 126 utilize respective receivers 514 and download managers 616 to receive and locally store the transmitted advertisement(s) 340 for viewing by the device users. The FIG. 7 process may then terminate. For at least the foregoing reasons, the present invention therefore provides an improved system and method for effectively supporting an advertisement distribution procedure in an electronic network.

The invention has been explained above with reference to certain embodiments. Other embodiments will be apparent to those skilled in the art in light of this disclosure. For example, the present invention may readily be implemented using certain configurations and techniques other than those described in the specific embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for supporting advertisement distribution in an electronic network, comprising:
an ad server that collects statistics for specifically targeting advertisements to device users in said electronic network;
client devices that said device users utilize for providing certain of said statistics to said ad server; and
a transmitter that broadcasts said advertisements to said client devices.

2. The system of claim 1 wherein said ad server utilizes a recommendation engine to perform an analysis procedure upon said statistics to identify optimal ones of said advertisements for broadcasting to said client devices.

3. The system of claim 1 wherein said transmitter is implemented as a high-power wireless transmitter device that broadcasts said advertisements according to transmission standards that are defined by an Advanced Television Systems Committee.

4. The system of claim 1 wherein said statistics include reported observations of contemporaneous occurrences, specific events from the recent or more distant past, information regarding one or more specific geographical locations, weather conditions, notifications of future scheduled events, device-user profile information, user device or network configurations, demographic data, Internet browsing patterns, information related to one or more commercial products, advertisement formats, and advertiser information for one or more advertisers.

5. The system of claim 1 wherein said client devices are implemented as personal computer devices.

6. The system of claim 1 wherein device users provide said certain of said statistics in response to one or more statistics questionnaires.

7. The system of claim 1 wherein said client devices automatically or manually provide statistics to said ad server.

8. The system of claim 1 wherein said ad server periodically polls said client devices and other entities to obtain said statistics.

9. The system of claim 1 wherein said client devices provides feedback information to said ad server to indicate whether said device users purchase one or more products as a result of said advertisements.

10. The system of claim 2 wherein said recommendation engine utilizes a pattern recognizer to analyze said statistics to generate pattern data for targeting said advertisements to said device users.

11. An electronic device for supporting an advertisement distribution procedure in an electronic network, comprising:
a device application that provides statistics to an ad server for specifically targeting advertisements to a device user of said electronic device;
a download manager that receives said advertisements from a transmitter that broadcasts said advertisements to said electronic device; and
a processor that controls said device application and said download manager.

12. The electronic device of claim 11 wherein said ad server utilizes a recommendation engine to perform an analysis procedure upon said statistics to identify optimal ones of said advertisements for broadcasting to said electronic device.

13. The electronic device of claim 11 wherein said transmitter is implemented as a high-power wireless transmitter device that broadcasts said advertisements according to transmission standards that are defined by an Advanced Television Systems Committee.

14. The electronic device of claim 11 wherein said statistics include reported observations of contemporaneous occurrences, specific events from the recent or more distant past, information regarding one or more specific geographical locations, weather conditions, notifications of future scheduled events, device-user profile information, user device or network configurations, demographic data, Internet browsing patterns, information related to one or more commercial products, advertisement formats, and advertiser information for one or more advertisers.

15. The electronic device of claim 11 wherein said electronic device is implemented as a personal computer device.

16. The electronic device of claim 11 wherein a device user provides said statistics in response to one or more statistics questionnaires.

17. The electronic device of claim 11 wherein said electronic device automatically or manually provide statistics to said ad server.

18. The electronic device of claim 11 wherein said ad server periodically polls said electronic device and other entities to obtain said statistics.

19. The electronic device of claim 11 wherein said electronic device provides feedback information to said ad server to indicate whether said device user purchases one or more products as a result of said advertisements.

20. The electronic device of claim 12 wherein said recommendation engine utilizes a pattern recognizer to analyze said statistics to generate pattern data for targeting said advertisements to said device user.
